(19) United States
(12) Patent Application Publication
(10) Pub. No.: US 2012/0096431 A1
(43) Pub. Date: Apr. 19, 2012

(54) METHOD AND APPARATUS FOR PROVIDING ADVERTISING DURING APPLICATION LOADING PROCESSES

(76) Inventor: YUVAL MADAR, Oakhurst, NJ (US)

(21) Appl. No.: 13/276,423

(22) Filed: Oct. 19, 2011

Related U.S. Application Data
(60) Provisional application No. 61/394,432, filed on Oct. 19, 2010.

(51) Int. Cl. G06F 9/44

(52) U.S. Cl. 717/110; 718/100

(57) ABSTRACT

A method and system in which a loading process of an application is controlled to present still or moving imagery such as advertisements, public service messages and the like to a user waiting for the application to load on a user device. Reporting and/or transacting mechanisms are provided to facilitate a business model between any of advertisement vendors (which supply the advertisements), application vendors (which adapt their code to display the advertisements) and advertising servers (which update user device advertisements and collect statistical data supporting the various transactions).

### CROSS-REFERENCE TO RELATED APPLICATIONS

This application claims the benefit of prior provisional patent application Ser. No. 61/394,432, filed on Oct. 19, 2010, entitled METHOD AND APPARATUS FOR PROVIDING ADVERTISING DURING APPLICATION LOADING PROCESSES, which application is incorporated herein by reference in its entirety.

### FIELD OF THE INVENTION

The invention relates generally to methods and systems for presenting imagery such as advertising imagery during an application loading process at a user device.

### BACKGROUND

Fixed and mobile computing devices including desktop computers, laptop computers, tablet computers, mobile telephones and the like execute applications in response to user requests. Prior to execution, the application must be loaded. During the application loading process, which is not instantaneous, a splash screen identifying the requested application, the version number and so on is often displayed as “eye candy” for the user. The time to load an application on a smartphone is usually a few seconds. During this time the user is watching the display of a user device to begin interacting with the application as soon as it is loaded.

### SUMMARY

Various embodiments for presenting imagery such as advertising imagery during an application loading process at a user device are depicted and described herein.

Various embodiments comprise method and system in which a “loading framework” is provided such that a loading process of an application is controlled to present still or moving imagery such as advertisements, public service messages and the like to a user waiting for the application to load on a user device. Reporting and/or transacting mechanisms are provided to facilitate a business model between any of advertisement vendors (which supply the advertisements), application vendors (which adapt their code to display the advertisements) and advertising servers (which update user device advertisements and collect statistical data supporting the various transactions).

In one embodiment, a method for presenting imagery at a user device includes receiving, via a user control device, an application load request; initiating a loading process for a primary function of the requested application; providing an image to a presentation device for display; updating an impression counter associated with the displayed image; selecting a next image to be displayed; and invoking the primary function of the requested application.

In one embodiment, an apparatus for presenting imagery at a user device includes a processor configured for receiving, via a user control device, an application load request; initiating a loading process for a primary function of the requested application; providing an image to a presentation device for display; updating an impression counter associated with the displayed image; selecting a next image to be displayed; and invoking the primary function of the requested application.

In one embodiment, a business model is provided wherein advertising vendors pay an advertisement serving entity for causing advertisements to be displayed on user devices during the period of time within which a selected application is loaded onto a user device. The payments may be based upon one or more of the number of user views or impressions of each advertisement, the duration of each impression (which may be adjusted in various embodiments), the time of day or date of the impression, the location of the user device, user demographic data and so on. Generally speaking, these and other advertisement revenue models may be used within the context of the various embodiments.

### BRIEF DESCRIPTION OF THE DRAWINGS

The various embodiments discussed herein can be readily understood by considering the following detailed description in conjunction with the accompanying drawings, in which:

FIG. 1 depicts a high-level block diagram of an exemplary system for enabling an advertising presentation and transaction capability;

FIG. 2 depicts a high-level block diagram illustrating one embodiment of a user device suitable for use in the system of FIG. 1;

FIG. 3 depicts a flow diagram of a method wherein a software development kit (SDK) is used to modify an application according to one embodiment;

FIG. 4 depicts a flow diagram of an advertisement presentation method according to one embodiment;

FIG. 5 depicts a flow diagram of a method for processing a newly received advertisement at the ad server/updater of FIG. 1;

FIG. 6 depicts a data structure useful in various embodiments of the invention.

FIG. 7 depicts a flow diagram of an advertisement vendor reconciliation method suitable for use by the ad server/updater of FIG. 1;

FIG. 8 depicts a flow diagram of advertisement update method suitable for use by a user device;

FIG. 9 depicts a high-level block diagram of a computer suitable for use in performing functions described herein;

FIG. 10 depicts a flow diagram according to one embodiment; and

FIG. 11 depicts a graphical representation of a mobile device useful in understanding the various embodiments.

To facilitate understanding, identical reference numerals have been used, where possible, to designate identical elements that are common to the figures.

### DETAILED DESCRIPTION OF THE INVENTION

Part of the invention lies in the recognition by the inventor that during the time necessary to load an application on a smartphone or other device (e.g., a few seconds),a user is likely watching the display of a user device to begin interacting with the application as soon as it is loaded. The user focus on the display during this time presents an excellent opportunity to provide advertising or other imagery or messages to the user.

Various embodiments will be described primarily within the context of a smartphone platform enabled by any of the various smartphone operating systems, including those associated with Blackberry, iPhone, Droid, Pixie, Windows mobile and so on. However, it will be appreciated by those skilled in the art that the particular platform and/or operating system may be adapted in response to the various teachings described herein.

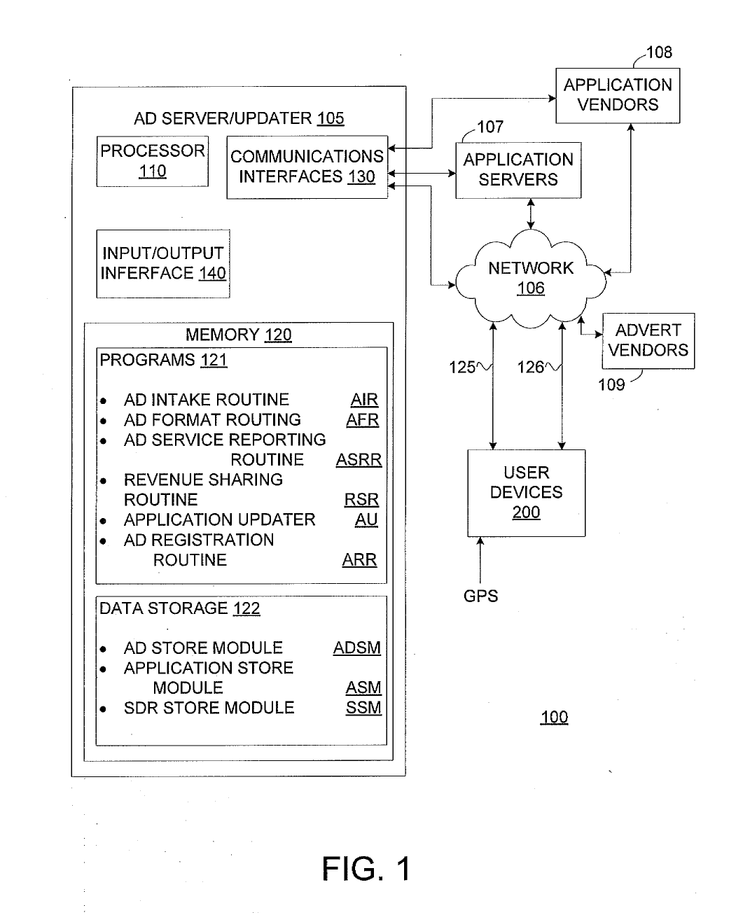

FIG. 1 depicts a high-level block diagram of an exemplary system for enabling an advertising presentation and transaction capability, such as the presentation of advertising or other imagery at a user device during an application load process as well as tracking/transaction/updating functions associated with such presentations.

Various embodiments for presenting imagery such as advertising imagery during an application loading process at a user device are depicted and described herein. In general, various embodiments may be described as a “loading framework” in which a loading process of an application is controlled to present still or moving imagery such as advertisements, public service messages and the like to a user waiting for the application to load on a user device. Reporting and/or transacting mechanisms are provided to facilitate a business model between any of advertisement vendors (which supply the advertisements), application vendors (which adapt their code to display the advertisements) and advertising servers (which update user device advertisements and collect statistical data supporting the various transactions).

As depicted in FIG. 1, exemplary system 100 includes an advertising server/updater 105, a network 106, application servers 107, application vendors 108, advertising vendors 109 and user devices 200. Network 106 may comprise one network or multiple networks. Moreover, network 106 may include Wi-Fi, WiMAX, 3G and or 4G wireless network capabilities to communicate with wireless user devices 200. Portions of network 106 may comprise optical, satellite or other network infrastructure to support back channel communications between server/updater 105, application vendors 108, application servers 108 and/or advertisement vendors 109.

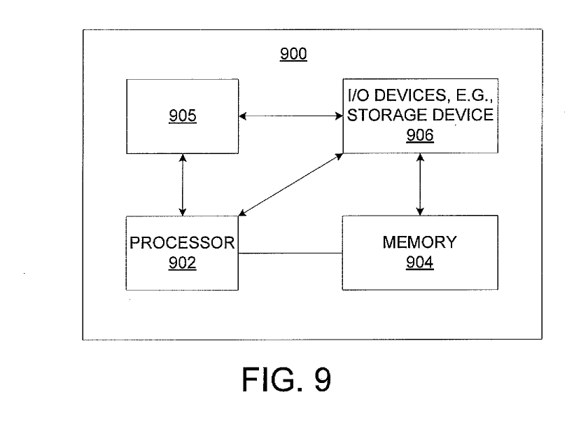

A specific hardware implementation associated with the advertising server/updater 105 will be discussed in detail. However, general computing infrastructure such as discussed with respect to the advertising server/updater 105, as well as the generic infrastructure discussed below with respect to FIG. 8, may be used to implement any of the functions associated with the application servers 107, application vendors 108, advertising vendors 109 and user devices 200.

Advertisement vendors 109 convey advertisements or other public or private messages to the ad server/updater 105 via network 106 or some other means (not shown). The conveyed advertisements or other messages may contain still or moving imagery.

Advertisement server/updater 105 receives the advertisements or other messages from the advertisement vendors 109, adapts the messages for use by the user devices 200, conveys the advertisements to the user devices 200, tracks impressions of the advertisements by the user devices and generally manages the business model/transactions associated with the various embodiments.

Various embodiments provide an analytics function in which statistics associated with advertisement views or impressions (e.g., number of times an application is opened per month, time of day application is opened and so on), consumer response to those views or impressions (interacted with the advertisement, ignored the advertisement etc.), explicit or implicit preferences with respect to advertisements and the like are collected for use by advertisement vendors and others. Moreover, since advertisement vendors may be providing advertisements via several different applications, application-specific statistics are also collected to assist advertisers in determining which applications are most useful in reaching their target demographic groups.

Application vendors 108 cooperate with the ad server/updater 105 to ensure that user applications provided to the user devices 200 are configured to support the advertising presentation and transaction capability of the various embodiments.

Application servers 107 are used to convey applications from application vendors 108 to the user devices 200 via network 106.

The advertising server/updater 105 includes a processor 110, a memory 120, communications interfaces 130, and input/output (I/O) interface 140. The processor 110 is coupled to each of memory 120, communication interfaces 130, and I/O interface 140.

The processor 110 is configured for controlling the operation of ad server/updater 105, including operations to provide the advertising presentation and transaction capability.

The memory 120 is configured for storing information suitable for use in providing the advertising presentation and transaction capability. Memory 120 may store programs 121, data 122 and the like.

In one embodiment, programs 121 may include one or more of an ad intake routine AIR, an ad format routine AFR, an ad tracking routine ATR, an ad service reporting routine ASRR, a revenue-sharing routine RSR, an application updater AU and an ad registration routine ARR. Various routines are combined as will be discussed in more detail below. The memory 120 may store any other information suitable for use by ad server/updater 105 in providing the advertising presentation and transaction capability.

The communications interfaces 130 include the necessary networking/communications capability to communicate with network 106 and/or directly with various other entities as discussed herein. It will be appreciated that fewer or more, as well as different, communications interfaces may be supported.

Although primarily depicted and described herein with respect to specific types, numbers, and arrangements of devices, networks, and other related elements, it will be appreciated that any other suitable types, numbers, and/or arrangements of devices, networks, and/or other related elements may be used for enabling the advertising presentation and transaction capability described herein.

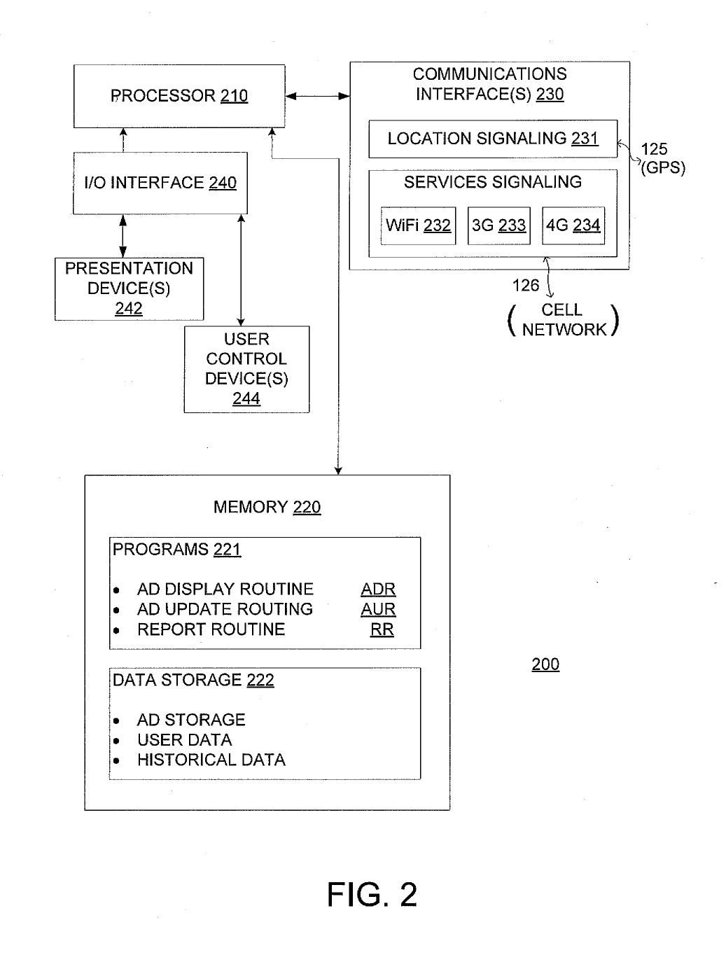

FIG. 2 depicts a high-level block diagram illustrating one embodiment of a user device suitable for use in the system of FIG. 1.

As depicted in FIG. 2, the user device 200 includes a processor 210, a memory 220, communications interfaces 230, input-output (I/O) interface 240, presentation interface(s) 242, and user control devices 244. The processor 210 is coupled to each of memory 220, communication interfaces 230, and I/O interface 240. The I/O interface 240 is coupled to presentation interface(s) 242 for presenting information on user device 200 (e.g., mobile phone display screen) and is coupled to user control interface(s) 244 (e.g., mobile phone touch screen or keypad input devices) for enabling user control of user device 200.

The processor 210 is configured for controlling the operation of user device 200, including operations to provide the advertising presentation and transaction capability.

The memory 220 is configured for storing information suitable for use in providing the advertising presentation and transaction capability. Memory 220 may store programs 221, data 222 and the like.

In one embodiment, programs 221 may include one or more of an ad display routine ADR, an ad update routine AUR, and a report routine RR. In one embodiment, data storage 222 may include one or more of added storage, user data, historical data and other data. The memory 220 may store any other information suitable for use by user device 200 in providing the advertising presentation and transaction capability.

The communications interfaces 230 may include a location signaling interface such as a global positioning GPS and or cellular telephone tower triangulation system to determine the location of the user device 200.

The communications interfaces 230 include one or more services signaling interface such as a Wi-Fi or WiMAX interface 232, a 3G wireless interface 233, and/or a 4G wireless interface 234 for supporting data/services signaling 126 between user device 200 and external communications and services infrastructure/network 106. It will be appreciated that fewer or more, as well as different, communications interfaces may be supported.

The I/O interface 240 provides an interface to the presentation interface(s) 242 and user control interface(s) 244 of user device 200.

The presentation interface(s) 242 includes any presentation interface(s) suitable for use in presenting information related to location-based data and services received at user device 200. For example, the presentation interface(s) 242 may include a display screen, one or more speakers, and the like, which may be used for displaying data, displaying video, playing audio, and the like, as well as various combinations thereof. The typical presentation interfaces of user device devices, including the design and operation of such interfaces, will be understood by one skilled in the art.

The user control interface(s) 244 include any user control interface(s) suitable for use in enabling the user of the user device 200 to interact with the user device 200. For example, the user control interfaces(s) 244 may include touch screen based user controls, stylus-based user controls, a keyboard and/or mouse, voice-based user controls, and the like, as well as various combinations thereof. The typical user control interfaces of user devices, including the design and operation of such interfaces, will be understood by one skilled in the art.

Although primarily depicted and described as having specific types and arrangements of components, it will be appreciated that any other suitable types and/or arrangements of components may be used for user device 200. The user device 200 may be implemented in any manner suitable for enabling the advertising presentation and transaction capability described herein.

### Application Loader Mechanism Supporting Ad Presentation

In one embodiment, the user device 200 includes an application loader program which intercepts application calls and responsively performs the advertising presentation and transaction steps described herein prior to calling the application itself.

### Modified Application Mechanism Supporting Ad Presentation

In one embodiment, applications are processed by the application vendors to support the advertising presentation and transaction capability described herein. In this embodiment, application vendors modify their application code to include initial function instructions for performing the advertising presentation and transaction steps described herein, and primary function instructions for performing the primary function of the application.

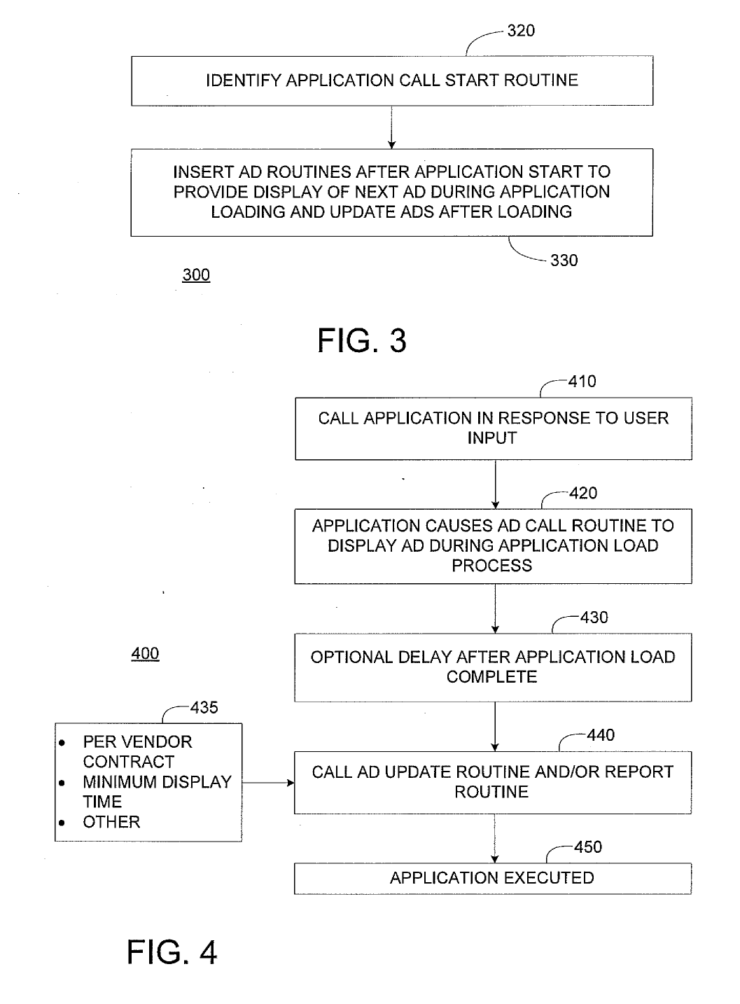

FIG. 3 depicts a flow diagram of a method wherein a software development kit (SDK) is used to modify an application according to one embodiment. For example, the SDK may be utilized by an application developer to adapt an application to support the advertising presentation and transaction capability described herein.

The method 300 starts at step 320, where the application call start routine is identified.

At step 330, processing routines in accordance with the various embodiments are inserted into the application after the application call start routine to provide thereby a mechanism to display an advertisement or other visual information prior to the loading of the application onto the user device. The inserted processing routines also include a mechanism to facilitate the updating of advertisements after loading so that a different advertisement may be presented the next time an application is loaded.

The inserted processing routines of step 330 generally include initial function instructions for performing the advertising presentation and transaction steps described herein. By contrast, the existing/remaining processing routines generally include primary function instructions for performing the primary function of the application.

FIG. 4 depicts a flow diagram of an advertisement presentation method according to one embodiment. The method 400 is entered at step 410 when an application is called in response to user input, such as selecting an icon on a display screen of a mobile device.

At step 420, the selected application causes an ad call routine to display an advertisement or other image during the application load process. That is, the advertisement or other image is displayed on, for example, the display screen of a mobile device while the selected application itself is loading.

At optional step 430, a delay is introduced after the application load is complete such that the advertisement or other information is displayed for a period of time exceeding the actual application load time. Referring to box 435, the amount of introduced delay is based on a vendor contract, a minimum display time associated with the advertisement, or some other criteria.

At step 440, an ad update routine and/or report routine is called. The advertisement update routine is used to determine a next advertisement to be displayed, update an impression counter or other data elements associated with the view of the advertisement (such as time of day, date, location and the like) and/or report any of this data or other data as appropriate to, illustratively, the ad server/updater 105.

At step 450, the requested application is executed.

Within the context of the modified application mechanism supporting advertising presentation discussed above with respect to FIGS. 3 and elsewhere, steps 420-440 may be invoked using initial function instructions while step 450 is invoked using primary function instructions. As previously noted, initial function instructions may be inserted into an application using a software development kit (SDK) or other mechanism by the application provider.

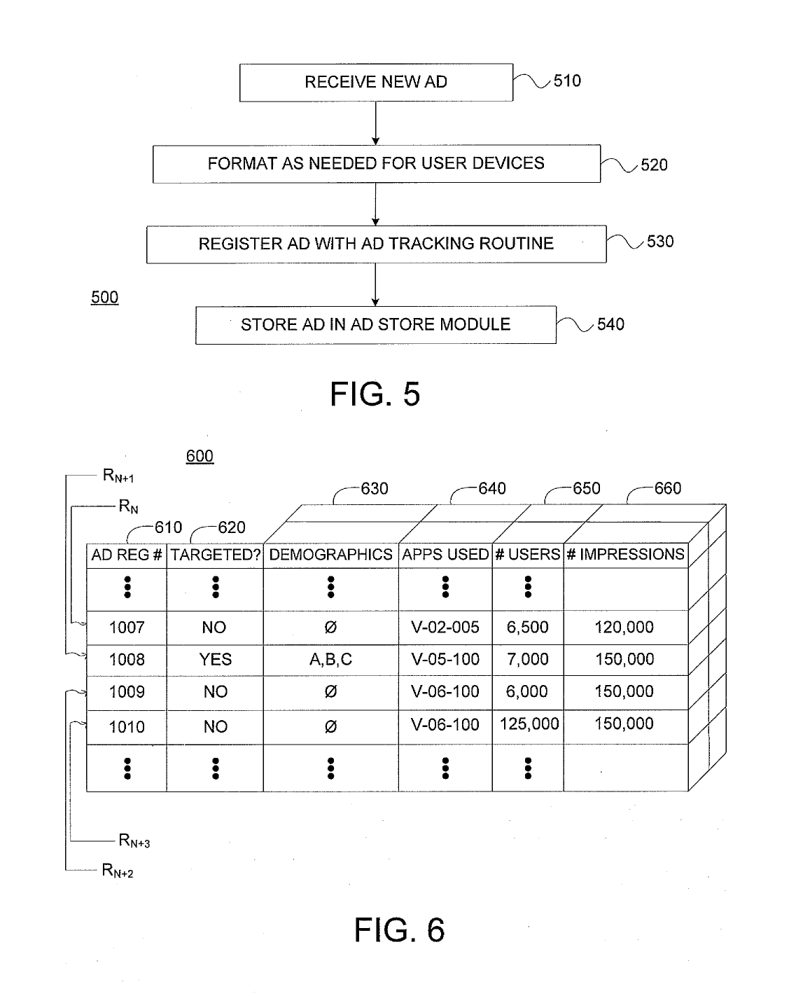

FIG. 5 depicts a flow diagram of a method for processing a newly received advertisement at the ad server/updater of FIG. 1. Specifically, at step 510 a new advertisement is received by the ad server/updater 105 from, illustratively, an advertisement vendor 109.

At step 520, the newly received advertisement is formatted as needed for the user devices 200. Specifically, the newly received advertisement may or may not be appropriate in terms of format. This is because different user devices 200 may require still or moving imagery having different image formats than an initial or native format of the newly received advertisement. For example, some user devices 200 may support video imagery while other user devices may not. Further, various mobile devices may have different size/resolution display screens, which display screens are optimized for particular format still or moving imagery. Generally speaking, formatting may be considered within the context of image size, still image compression type (e.g., JPEG versus bitmap), moving image compression type (e.g., H.261 versus MPEG) and so on.

At step 530, the advertisement is registered with the ad tracking routine ATR so that user impressions associated with the advertisement may be provided to the advertiser as part of a reconciliation or business transaction/process wherein the advertiser pays for each impression as described above.

At step 540, the initial, formatted and or reformatted advertisement is stored in an advertisement storage module within the ad server/updater 105. In the various embodiments, each advertisement may be stored multiple times according to multiple formats.

FIG. 6 depicts a data structure useful in various embodiments of the invention. For example, the data structure 600 of FIG. 6 may be used by the ad server/updater 105, user devices 200 and other elements described herein to provide a common data structure for storing information pertaining to the advertising presentation and transaction methods described herein.

Specifically, the data structure 600 of FIG. 6 contemplates a plurality of records though for simplicity only records R_{N} through R_{N+3} are depicted. Each record has a plurality of fields, illustratively an add registration number field 610, a targeted advertisement tag field 620, a demographic profile field 630, an applications used field 640, a number of users field 650 and a number of impressions field 660. More, fewer and/or different fields may be used.

The ad registration field 610 stores the registration number associated with a specific advertisement. The targeted advertisement tag field 620 indicates whether or not the registered ad is targeted to a specific demographic user/viewer. The demographic profile field 630 is used to store codes indicative of the appropriate demographic user/viewer of a targeted ad. The applications used field 640 is used to store information identifying the specific applications intended to display the corresponding registered advertisement. Number of users field 650 is used to store the number of users of the applications displaying the advertisement. Number of impressions field 660 is used to store the number of user views or impressions of the advertisement.

Fields 630-660 are graphically depicted as having a third dimension to illustrate that various combinations of demographic profiles, applications used, number of users, and/or impressions may be utilized and stored with the data structure 600 of FIG. 6.

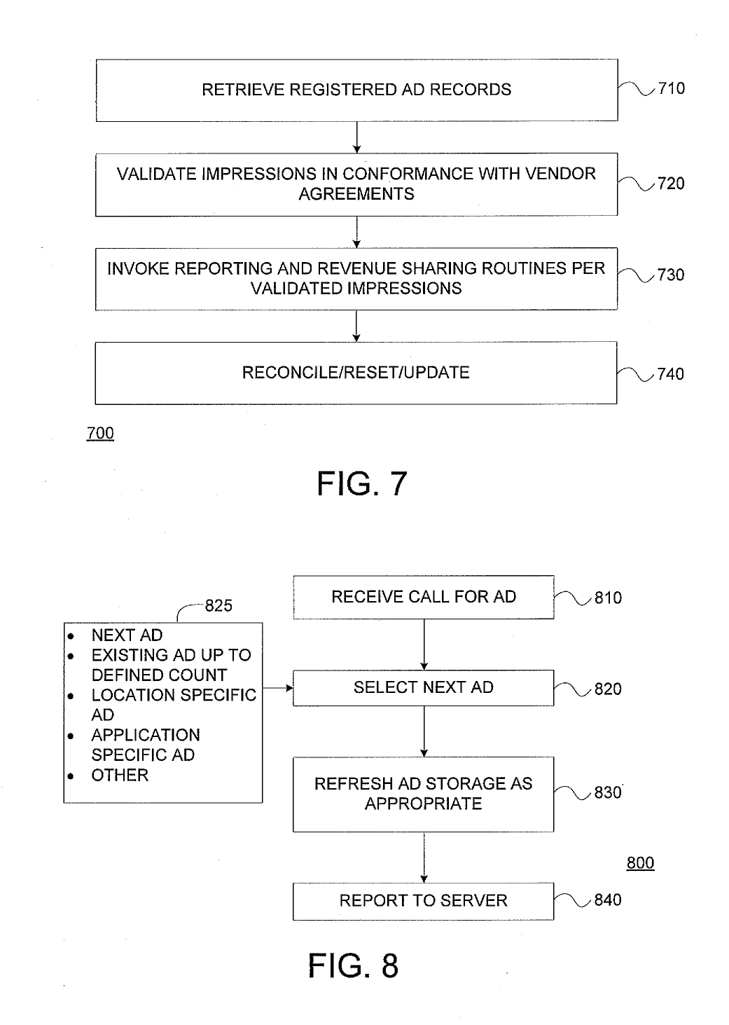

FIG. 7 depicts a flow diagram of an advertisement vendor reconciliation method suitable for use by the ad server/updater 105. The method 700 of FIG. 7 is entered at step 710, when the records associated with a registered ad are retrieved.

At step 720, the user/viewer impressions associated with an advertisement are validated in conformance with vendor agreements. For example, in the case of a vendor agreement where specific demographics are required, those impressions not associated with the specific demographic are not valid.

At step 730, reporting and revenue-sharing routines are invoked per the validated impressions. That is, based upon the validated impressions associated with a particular advertisement, reports are provided to the advertisement vendor to show the data associated with the validated impressions and invoices or billing memos are provided to document the money owed by the advertising vendors due to the validated impressions.

At step 740, various business reconciliation, reporting reconciliation, reset, update and/or other administrative functions are performed.

FIG. 8 depicts a flow diagram of advertisement update method suitable for use by a user device 200.

At step 810 a call for an ad to be displayed is received from an application.

At step 820, a next advertisement to be displayed by the application is selected. Referring to box 825, the selection of the next ad for display may be the next advertisement in a list of advertisements, the presently displayed or existing ad if a defined impression count of that ad has not yet been reached, a location specific advertisement such as where a user device is proximate a source of advertised goods or services, and an application specific advertisement such as an add-on software component to the application or some other selection criteria.

At step 830, the ad storage is refreshed as appropriate. That is, a typical user device 200 can store a finite number of advertisements. If the criteria associated with the presentation of advertisements presently stored in the user device indicates that new advertisers should be stored, then the advertisement storage at these a device is refreshed by providing replacement advertisements.

At step 840, the device reports advertisement impression data to the server 105.

A system, method, software development kit (SDK), computer readable medium, computer program product and so forth providing an advertising presentation and transaction capability are described herein.

FIG. 9 depicts a high-level block diagram of a computer suitable for use in performing functions described herein.

As depicted in FIG. 9, computer 900 includes a processor element 902 (e.g., a central processing unit (CPU) and/or other suitable processor(s)), a memory 904 (e.g., random access memory (RAM), read only memory (ROM), and the like), a cooperating module/process 905, and various input/output devices 906 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 905 can be loaded into memory 904 and executed by processor 902 to implement the functions as discussed herein. Thus, cooperating process 905 (including associated data structures) can be stored on a computer readable storage medium, e.g., RAM memory, magnetic or optical drive or diskette, and the like.

It will be appreciated that computer 900 depicted in FIG. 9 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a tangible or intangible data stream in a broadcast or other signal bearing medium, and/or stored within a memory within a computing device operating according to the instructions.

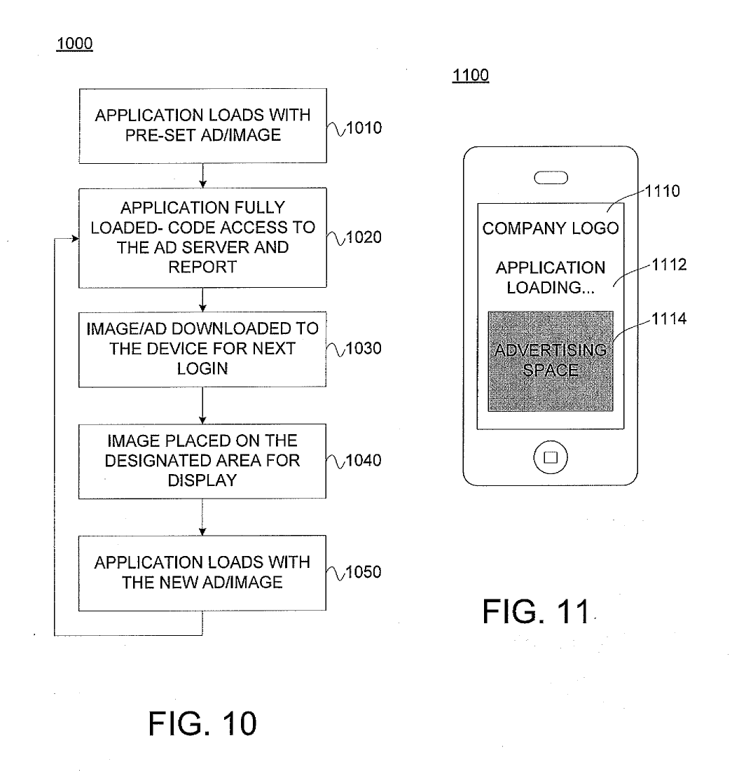

FIG. 10 depicts a flow diagram according to one embodiment. In particular, FIG. 10 depicts a method suitable for implementation of a mobile device such as a smart phone, tablet computer and the like. FIG. 11 depicts a graphical representation of a mobile device, illustratively a smart phone, useful in understanding the various embodiments.

At step 1010, a user-selected application is loaded into memory of the mobile device while an initial or pre-set advertisement or image is displayed. The pre-set advertisement or image may be included within the application, may be a default advertisement or image associated with the application and/or the mobile device, may be a next advertisement or image in a sequence of advertisements or images and so on. The advertisement or image may be displayed within, illustratively, an advertising space portion 1114 of a display region 1110 of the mobile device 1100.

At step 1020, after the application is fully loaded, the mobile device may access an advertising server and report to it that the predefined advertisement or image has been viewed (i.e., an impression of the advertisement or image is recorded) by a user via a mobile device, by a particular user via a mobile device, or by a particular user via a particular mobile device. Moreover, the specific application invoked by the user may also be reported to the ad server. In addition, some or all of this information may be reported to other entities, such as application vendors, application servers and advertising vendors.

At step 1030, a new advertisement or image is downloaded to a mobile device for presentation to the user of the mobile device when the user next invokes the application (or, illustratively, another application).

At step 1040, in response to the user invoking the application (or, illustratively, another application), the advertisement or image downloaded by the mobile device at step 1030 is displayed within the advertising space portion 1114 of a display region 1110 of the mobile device 1100.

At step 1050, the invoked application loads while the advertisement or image displayed at step 1040 remains visible to the user. The method 1000 repeat steps 1020-1050 to report the advertisement impression and retrieve new advertisements/images as needed.

Although various embodiments which incorporate the teachings of the present invention have been shown and described in detail herein, those skilled in the art can readily devise many other varied embodiments that still incorporate these teachings.

What is claimed is:

1. A method for presenting imagery at a user device, comprising:
receiving, via a user control device, an application load request;
initiating a loading process for a primary function of the requested application;
providing an image to a presentation device for display;
updating an impression counter associated with the displayed image;
selecting a next image to be displayed; and
invoking the primary function of the requested application.

2. The method of claim 1, wherein the selected image comprises one of an advertisement and a public service message.

3. The method of claim 1, wherein the displayed imagery comprises still imagery.

4. The method of claim 1, wherein the next image to be displayed is selected using one or more of user device location data, user demographic data, time of day data, date data, application identification and impression count.

5. The method of claim 1, further comprising waiting for said image to be displayed for a predetermined amount of time prior to executing the requested application.

6. The method of claim 1, wherein the requested application comprises initial function instructions for performing the steps of providing, updating and selecting, and primary function instructions for performing the primary function of the application.

7. The method of claim 1, wherein an application loader program invoked in response to the application request comprises initial function instructions for performing the steps of providing, updating and selecting.

8. The method of claim 1, wherein a server in communication with the user device transacts with a vendor in response to impression counter information provided by a group of user devices.

9. The method of claim 8, wherein the server correlates the impression counter information to one or more of user device location data, user demographic data, time of day data, date data and application identification prior to transacting with the vendor.

10. An apparatus, comprising a processor configured for:
receiving, via a user control device, an application load request;
initiating a loading process for a primary function of the requested application;
providing an image to a presentation device for display;
updating an impression counter associated with the displayed image;
selecting a next image to be displayed; and
invoking the primary function of the requested application.

11. A software development kit (SDK) which, when executed via a computer, processes existing computer instructions associated with a primary function of an application according to the steps of:
adding computer instructions associated with an initial function to the existing computer instructions to provide combined computer instructions which, when executed by a computer, perform a method comprising the initial function followed by the primary function of the application;
wherein the initial function comprises:
initiating a loading process for the primary function instructions of the application;
providing an image to a presentation device for display;
updating an impression counter associated with the displayed image;
selecting a next image to be displayed; and
invoking the primary function of the requested application.
